(19) United States
(12) Patent Application Publication
(10) Pub. No.: US 2014/0313747 A1
(43) Pub. Date: Oct. 23, 2014

(54) LIGHT EMITTING DIODE LIGHT BULB TROFFER

(71) Applicant: Robert Behnejad, Pembroke Pines, FL (US)

(72) Inventor: Robert Behnejad, Pembroke Pines, FL (US)

(21) Appl. No.: 14/256,524

(22) Filed: Apr. 18, 2014

Related U.S. Application Data
(60) Provisional application No. 61/813,580, filed on Apr. 18, 2013.

(51) Int. Cl. F21K 99/00

(52) U.S. Cl. CPC F21K 9/30
USPC 362/362

(57) ABSTRACT

A light emitting diode light bulb troffer is provided. The present invention includes a light fixture with a recessed cavity portion. At least one bulb housing can is attached to the recessed cavity portion of the light fixture. A light emitting diode light bulb may be inserted and used with the light fixture.

### CROSS-REFERENCE TO RELATED APPLICATION

This application claims the benefit of priority of U.S. provisional application No. 61/813,580, filed Apr. 18, 2013, the contents of which are herein incorporated by reference.

### BACKGROUND OF THE INVENTION

The present invention relates to a troffer and, more particularly, to a light emitting diode light bulb troffer.

Currently, fluorescent lights may be used for troffers. Specifically, the T8 fluorescent tube is very commonly used with current troffers. However, different troffers may require different installation procedures for changing the T8 lights.

Even the new LED T8 tubes that are being used for the replacement of the regular florescent T8 do not have an installation standard. Once the life of the LED tube is over, the user must locate the proper LED T8 to meet the current installation set up. Further, even when using LED panels, once the life is over, the user must replace the whole panel.

As can be seen, there is a need for a light emitting diode light bulb troffer.

### SUMMARY OF THE INVENTION

In one aspect of the present invention, a troffer comprises: a light fixture comprising a recessed cavity portion having a top surface and a bottom surface, wherein the recessed cavity portion comprises at least one opening therethrough; at least one bulb housing can mounted to the top surface of the recessed cavity portion, wherein the at least one bulb housing can comprises a rim forming an opening, wherein the opening of the at least one bulb housing is aligned with the at least one opening of the recessed cavity, wherein the at least one bulb housing can is formed to receive a light emitting diode bulb; and a junction power box wired to the at least one bulb housing can by a power line.

These and other features, aspects and advantages of the present invention will become better understood with reference to the following drawings, description and claims.

### BRIEF DESCRIPTION OF THE DRAWINGS

FIG. 1 is a bottom perspective view of the present invention shown in use;

FIG. 2 is a top perspective view of the present invention;

FIG. 3 is an exploded view of the present invention;

FIG. 4 is a section view of the present invention along line 4-4 in FIG. 2;

FIG. 5 is a bottom perspective view of an alternate embodiment of the present invention shown in use;

FIG. 6 is a top perspective view of the present invention;

FIG. 7 is an exploded view of the present invention; and

FIG. 8 is an exploded view of an alternate embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a light emitting diode light bulb troffer. The present invention includes a light fixture with a recessed cavity portion. At least one bulb housing can is attached to the recessed cavity portion of the light fixture. A light emitting diode light bulb may be inserted and used with the light fixture.

The present invention includes a replacement of the ceiling lighting troffer from the florescent tube or T8 to a regular LED bulb using par 38 bulbs. The present invention leads to less consumption of energy. The present invention allows users to mix any color, any size, and any power usage bulbs. The user can easily replace the bulb once the life is over without worrying about determining the installation procedures or finding a replacement LED that fits within the particular troffer. The present invention allows a user to simply change a bulb to a more efficient new bulb.

The present invention may eliminate the need for ballast and polarity concerns while providing the unmatched versatility of medium-base lamps. Unlike tubes, these lamps can be dimmed and directed, and are available in a wide range of shapes, sizes, color temperatures and angles. Additionally, the present invention may be a permanent fixture providing an easy and inexpensive way of replacing existing inefficient fluorescent fixtures with state-of-the-art LED lamps that provide better lighting at a fraction of the energy cost. LED lamps quickly pay for themselves due to energy savings, and provide continued savings for many years. The present invention also provides a different, more contemporary look.

Installation of the troffer panel of the present invention is easy. The old fluorescent troffer is simply removed, and the troffer panel of the present invention is dropped in its place and plugged into the power supply. The troffer panel of the present invention may include standard one lamp, three lamp, and four lamp sizes, and can be painted to match the user's desired look.

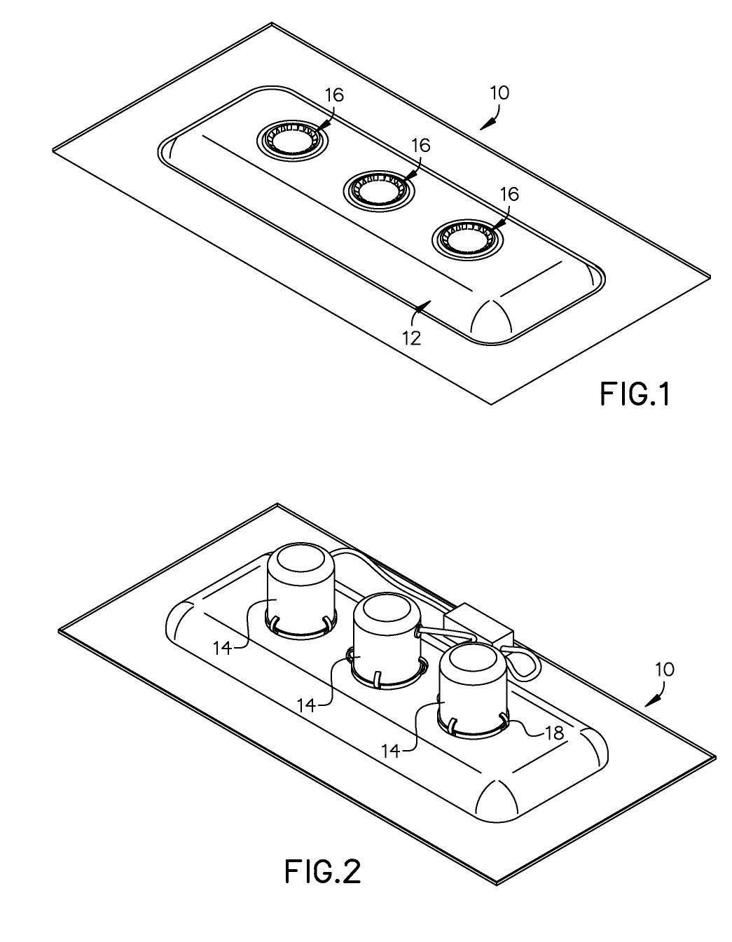

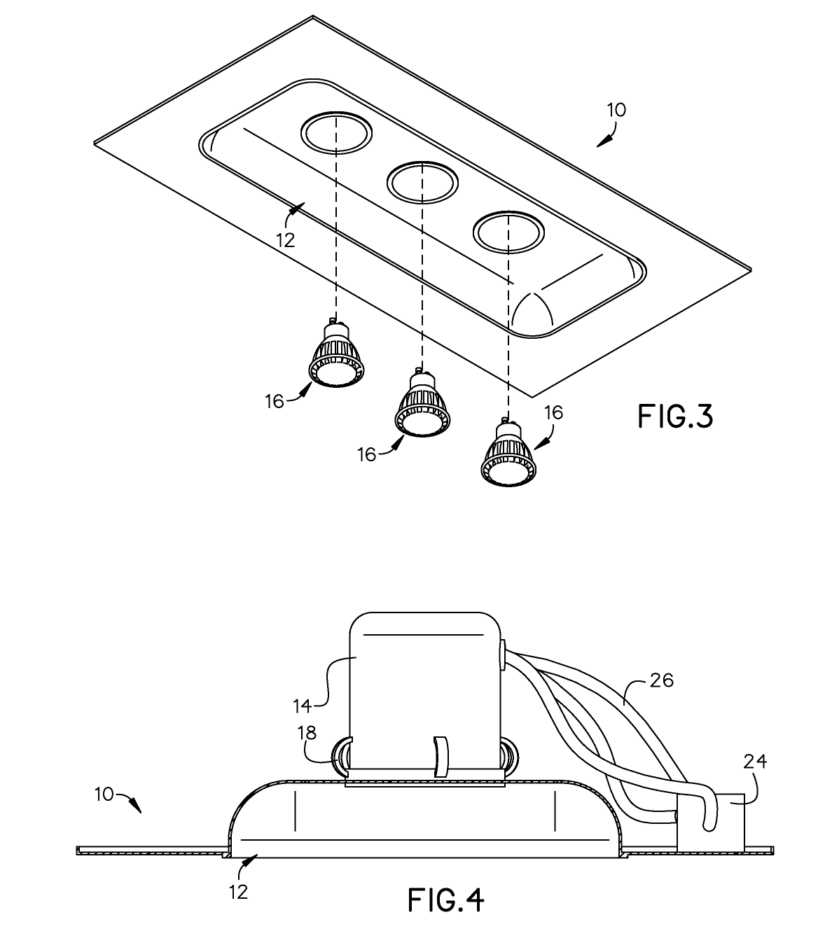

Referring to FIG. 1 through 8, the present invention includes a light fixture 10, such as a lay in troffer. The light fixture 10 of the present invention may include an elongated rectangular shape or a square shape 20. The light fixture 10 may be made using an ABS plastic UL HB 94 rated panel material part number: P24 or P22. The light fixture 10 includes a recessed cavity portion 12 having a top surface and a bottom surface. The recessed cavity portion 12 may include about a 6″ recessed cavity portion 12 using part number HS6-2001. The recessed cavity portion 12 may include at least one opening therethrough. For example, the recessed cavity portion 12 may include a plurality of openings, such as three or four openings. The openings may be circular.

The present invention may further include a bulb housing can 14 having a rim forming an opening that leads into the bulb housing can 14. The bulb housing can 14 is formed to receive a light emitting diode bulb 16. For example, the bulb housing can 14 may receive a PAR38 light emitting diode bulb 16. The bulb housing can 14 is mounted to the top surface of the recessed cavity portion 12 so that the opening of the bulb housing can 14 aligns with the opening of the recessed cavity portion 12. Therefore, a user may easily insert a bulb 16 into the bulb housing can 14 through the recessed cavity portion 12.

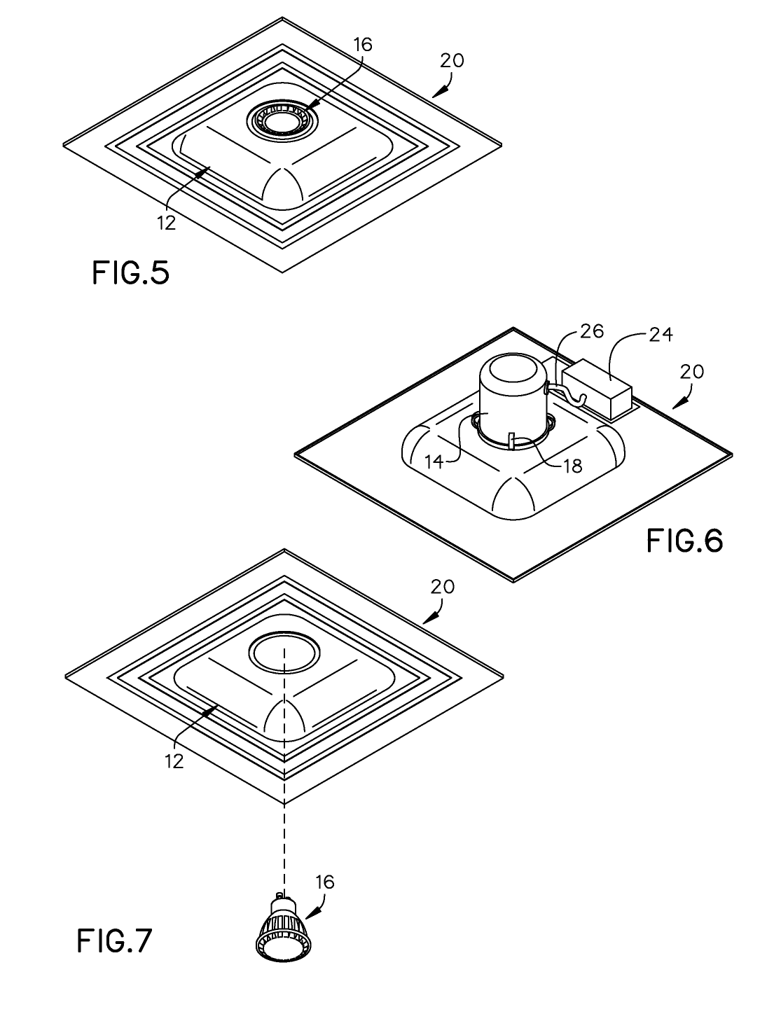

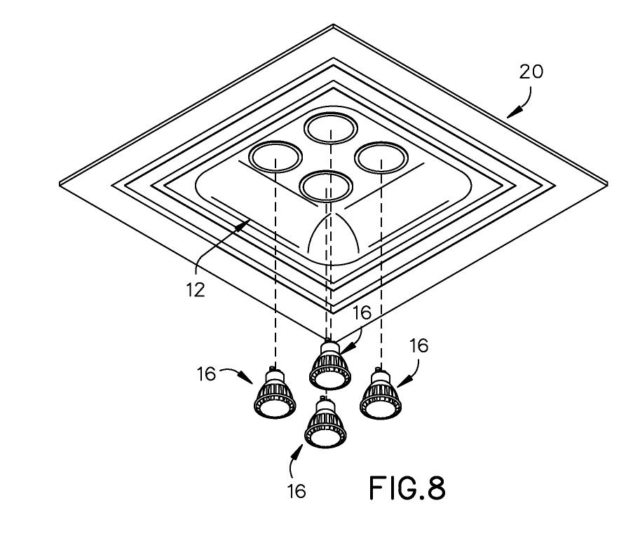

As mentioned above, the recessed cavity portion 12 may include a plurality of openings. In such embodiments, a plurality bulb housing cans 14 may be utilized. Therefore, each bulb housing can 14 may match with a single opening. As illustrated in FIGS. 1 through 3, the recessed cavity portion 12 may include three openings, and therefore three bulb housing cans 14 may be utilized. As illustrated in FIGS. 5 through 7, the recessed cavity portion 12 may include a single opening, in which a single bulb housing can 14 is utilized. As illustrate in FIG. 8, the recessed cavity 12 may include four openings in which four bulb housing cans 14 are utilized.

In certain embodiments, the bulb housing cans 14 may be mounted to the top surface of the recessed cavity portion 12 by housing clips 18. A rim may be attached around the perimeter of the openings of the recessed cavity portion 12. The rim may include a plurality of clips 18 protruding from the top surface of the recessed cavity portion 12. The bulb housing can 14 may be placed in between the clips 18 and thereby secured to the top surface of the recessed cavity portion 12.

The present invention may further include a junction power box 24, such as part number JB-401. The junction power box 24 may supply power to the bulb housing cans 14 and thereby supply power to the light bulbs 16. As illustrated in FIG. 6, a single junction power box 24 may be wired to a single bulb housing can 14 by a power line 26. In certain embodiments, a single junction power box 24 may be wired to a plurality of bulb housing cans 14. As illustrated in FIG. 10, a power line 26 may connect each of the bulb housing cans 14 to the junction power box 24 powering all of the bulb housing cans 14. The junction power box 24 of the present invention may be separated from the bulb housing cans 14, adding the ground wire to the power line 26, and extending the power line 26, allowing the junction box 24 to accommodate a plurality of bulb housing cans 14 at the same time. Therefore, the junction power box 24 may be placed anywhere suitable for installation.

In certain embodiments, utilizing the present invention, the user may use different coloring bulbs at anytime. For example the user may use color changing LED bulbs for special occasions or business parties to change the ambiance. The present invention may be used for manufacturing facility lighting, warehouse lighting, night clubs, and the like. The present invention may accommodate any drop ceiling area.

It should be understood, of course, that the foregoing relates to exemplary embodiments of the invention and that modifications may be made without departing from the spirit and scope of the invention as set forth in the following claims.

What is claimed is:

1. A troffer comprising:
a light fixture comprising a recessed cavity portion having a top surface and a bottom surface, wherein the recessed cavity portion comprises at least one opening therethrough;
at least one bulb housing can mounted to the top surface of the recessed cavity portion, wherein the at least one bulb housing can comprises a rim forming an opening, wherein the opening of the at least one bulb housing is aligned with the at least one opening of the recessed cavity, wherein the at least one bulb housing can is formed to receive a light emitting diode bulb; and
a junction power box wired to the at least one bulb housing can by a power line.

2. The troffer of claim 1, wherein the opening of the at least one bulb housing can is circular.

3. The troffer of claim 1, further comprising a plurality of openings through the recessed cavity, wherein a plurality bulb housing cans are mounted to the top surface of the recessed cavity portion, wherein each of the plurality of bulb housing cans is covering one of the plurality of openings.

4. The troffer of claim 3, wherein the plurality of bulb housing cans are wired by a plurality of power lines to a single junction power box.

5. The troffer of claim 3, wherein the plurality of openings through the recessed cavity is three openings, and wherein the plurality of bulb housing cans is three bulb housing cans.

6. The troffer of claim 1, wherein the light fixture is an elongated rectangular shape.

7. The troffer of claim 1, wherein the light fixture is a square shape.

8. The troffer of claim 1, wherein the light emitting diode bulb is secured within the at least one bulb housing can.

9. The troffer of claim 7, wherein the light emitting diode bulb is PAR38 light emitting diode bulb.

10. The troffer of claim 1, wherein the at least one bulb housing can is mounted to the top surface of the recessed cavity portion by a plurality of housing clips.
